(19) United States
(12) Patent Application Publication
(10) Pub. No.: US 2003/0174123 A1
(43) Pub. Date: Sep. 18, 2003

(54) Wireless mouse and keyboard assembly

(76) Inventor: Kuo Shu Cheng, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/098,515

(22) Filed: Mar. 18, 2002

(51) Int. Cl. G09G 5/08

(52) U.S. Cl. 345/163

(57) ABSTRACT

A wireless mouse and keyboard assembly comprises a wireless mouse and a keyboard. The wireless mouse has a wireless emitter therein and emitting a wireless signal. The keyboard has a wireless receiver receiving the wireless signal from the wireless emitter. The keyboard converts the received wireless signal to a digital signal, which is sent to a computer through a connection cord connected between the keyboard and the computer. The wireless mouse and keyboard assembly has reduced space and cost.

### FIELD OF THE INVENTION

The present invention relates to a wireless mouse and keyboard assembly, especially to a wireless mouse and keyboard assembly, wherein a keyboard receiving signal from a wireless mouse and sending the signal to a computer.

### BACKGROUND OF THE INVENTION

The mice and keyboards are widely used for input means for computer. The conventional mice and keyboards are generally connected to the computer through connection cord to convey signal and electrical power. However, the connection cord of mouse and keyboard results in littery problem. More particularly, the movement of the mouse is hindered.

To solve this problem, a wireless mouse is developed, which has a wireless emitter 11a and a wireless receiver 2a to replace the conventional connection cord as shown in FIG. 1. The wireless emitter 11a is arranged in a wireless mouse 1a and the wireless receiver 2a is arranged externally. However, in this arrangement, the wireless receiver 2a still occupies certain space. The wireless mouse 1a and the keyboard are independent devices and lack of integration. This causes the problem of wasting space and higher cost.

### SUMMARY OF THE INVENTION

It is the object of the present invention to provide a wireless mouse and keyboard assembly to reduce occupied space and cost.

To achieve above object, the present invention provides a wireless mouse and keyboard assembly having a wireless mouse and a keyboard. The wireless mouse has a wireless emitter therein and emitting a wireless signal. The keyboard has a wireless receiver receiving the wireless signal from the wireless emitter. The keyboard converts the received wireless signal to a digital signal, which is sent to a computer through a connection cord connected between the keyboard and the computer. The wireless mouse and keyboard assembly has reduced space and cost.

The various objects and advantages of the present invention will be more readily understood from the following detailed description when read in conjunction with the appended drawing, in which:

### BRIEF DESCRIPTION OF DRAWINGS

FIG. 1 shows a schematic view of a prior art wireless mouse;

FIG. 2 shows a block diagram of the wireless mouse and keyboard assembly of the present invention;

FIG. 3 shows another block diagram of the wireless mouse and keyboard assembly of the present invention;

FIG. 4 shows the first preferred embodiment of the present invention;

FIG. 5 shows the second preferred embodiment of the present invention; and

FIG. 6 shows the third preferred embodiment of the present invention.

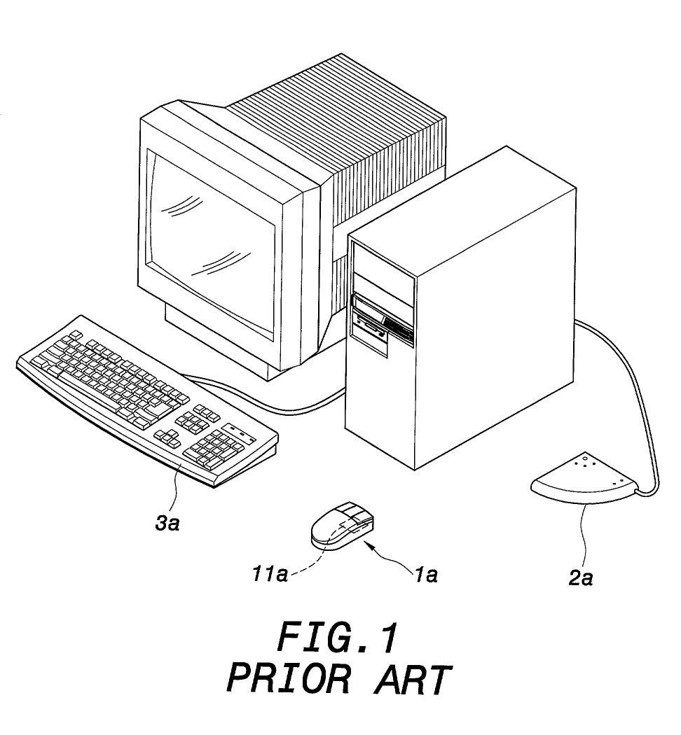

### DETAILED DESCRIPTION OF THE INVENTION

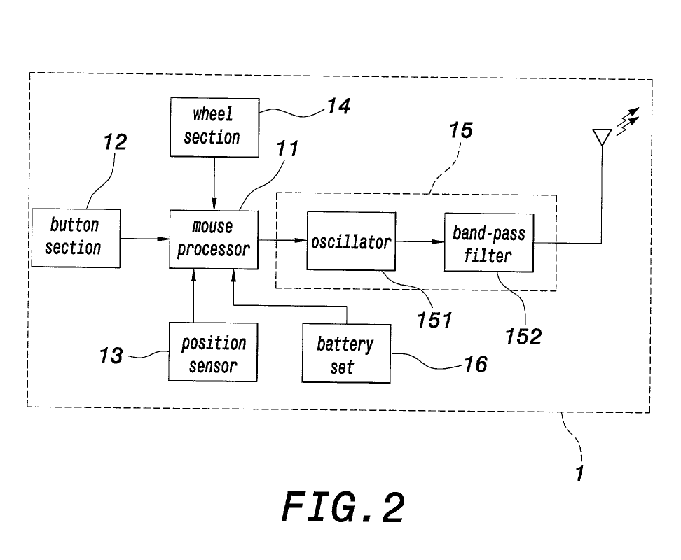

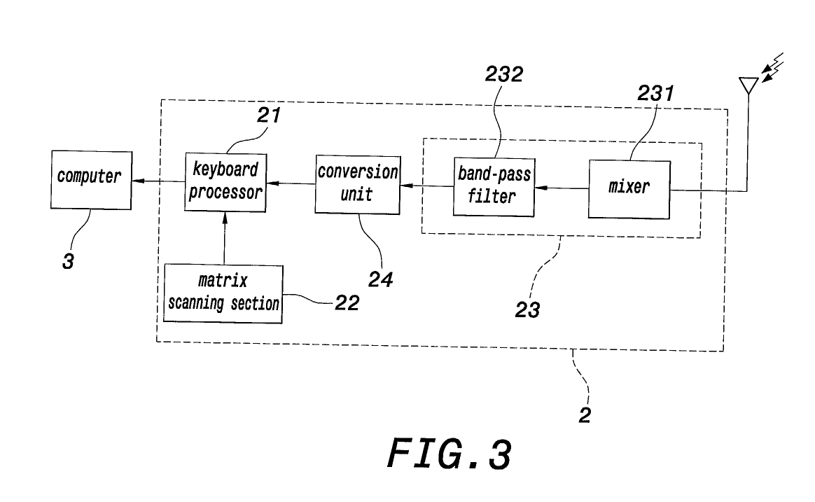

FIGS. 2 and 3 show the block diagrams of the wireless mouse and keyboard assembly of the present invention. The wireless mouse and keyboard assembly of the present invention comprises a wireless mouse 1 and a keyboard 2.

As shown in FIG. 2, the wireless mouse 1 comprises a mouse processor 11, a button section 12, a position sensor 13, a wheel section 14 and a wireless emitter 15. The mouse processor 11 calculates the data for determine the movement of the wireless mouse 1. The button section 12 senses button-pressing action against the wireless mouse 1 and sends a detection signal to the mouse processor 11. The position sensor 13 detects the movement of the wireless mouse 1 and sends a detection signal to the mouse processor 11. The wheel section 14 senses the rotation of a wheel of the wireless mouse 1 and sends a detection signal to the mouse processor 11. The wireless emitter 15 converts a processed signal from the wireless mouse 1 into a wireless signal in RF (radio frequency) band, and is composed of an oscillator 151 and a band-pass filter 152. Moreover, the wireless mouse 1 further comprises a battery set 16 to supply electric power to the wireless mouse 1.

The keyboard 2 comprises a keyboard processor 21, a matrix scanning section 22, a wireless receiver 23 and a conversion unit 24. The keyboard processor 21 processes the keystroke operation and the manipulation of wireless transmission signal. The matrix scanning section 22 is used to sense the keystroke operation and sends a signal to the keyboard processor 21. The wireless receiver 23 is used to receive wireless signal from the wireless mouse 1 and composed of a mixer 231 and a band-pass filter 232. The conversion unit 24 is used convert a wireless signal from the wireless receiver 23 into a digital signal, which is sent to the keyboard processor 21 for further processing. The keyboard processor 21 then sends the processed signal to the computer 3.

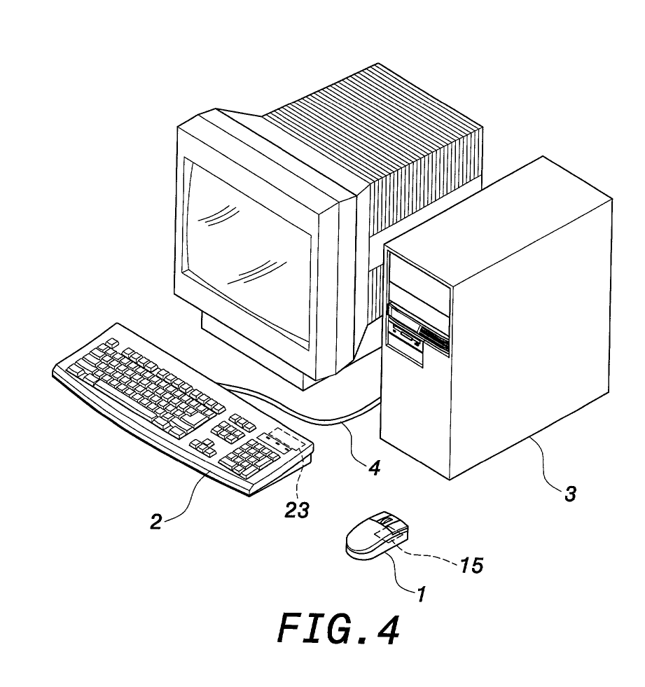

FIG. 4 shows the first preferred embodiment of the present invention, wherein the wireless mouse and keyboard assembly is applied for a computer. The wireless emitter 15 of the wireless mouse 1 sends a wireless signal, which is received by the wireless receiver 23 of the keyboard 2. The wireless signal is then processed by the keyboard 2 and sent to the computer 3.

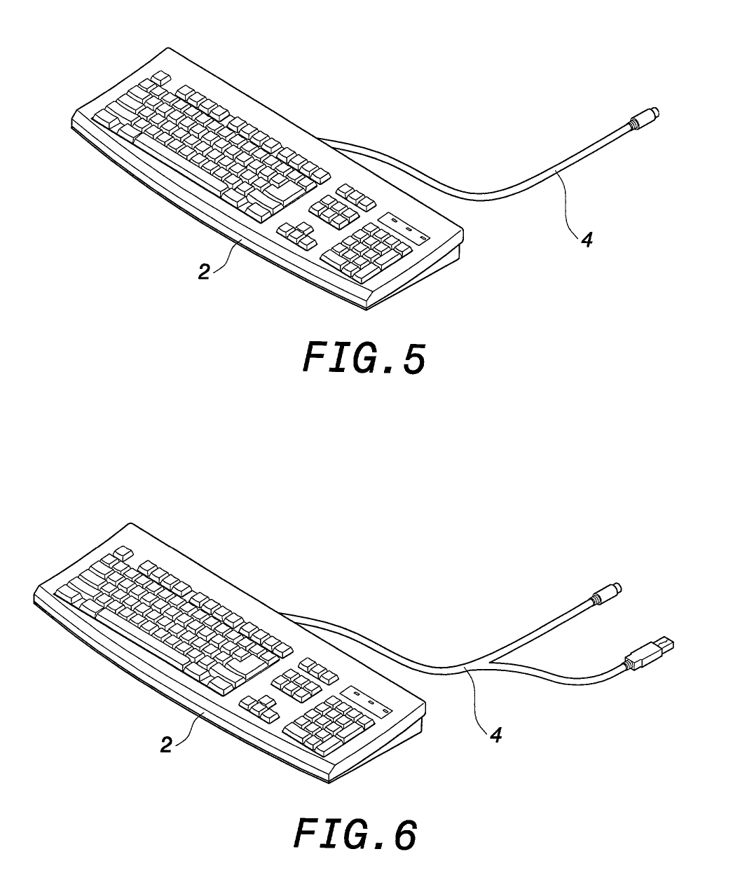

FIG. 5 shows the second preferred embodiment of the present invention, wherein the keyboard 2 is connected to the computer 3 through a connection cord with one end being a PS/2 (or USB) connector.

FIG. 6 shows the third preferred embodiment of the present invention, wherein the keyboard 2 is connected to the computer 3 through a connection cord with end having a PS/2 connector and a USB connector, respectively.

To sum up, the wireless mouse and keyboard assembly of the present invention has following advantages:

1. The wireless receiver is built in the keyboard and used to receive the wireless signal from the wireless mouse, thus reducing occupied space and cost.

2. The wireless receiver is removed from desktop, whereby the movable range of the wireless mouse is increased.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A wireless mouse and keyboard assembly, comprising a wireless mouse having a wireless emitter therein and emitting a wireless signal;
a keyboard having a wireless receiver receiving the wireless signal from the wireless emitter, the keyboard converting the received wireless signal to a digital signal, which is sent to a computer through a connection cord connected between the keyboard and the computer.

2. The wireless mouse and keyboard assembly as in claim 1, wherein the wireless mouse comprises:
a mouse processor processing a movement data of the wireless mouse into a wireless signal, and sending the wireless signal through the wireless emitter;
a button section sensing button-pressing action against the wireless mouse and sending a detection signal to the mouse processor;
a position sensor detecting the movement data of the wireless mouse and sending a detection signal to the mouse processor; and
a wheel section sensing the rotation of a wheel of the wireless mouse and sending a detection signal to the mouse processor.

3. The wireless mouse and keyboard assembly as in claim 1, wherein the keyboard comprises:
a keyboard processor processing a keystroke operation and the manipulation of wireless data, the processed wireless data being sent to the computer;
a matrix scanning section used to sense the keystroke operation and send a signal to the keyboard processor; and
a conversion unit used convert the wireless signal from the wireless receiver into a digital signal, which is sent to the keyboard processor for further processing.

4. The wireless mouse and keyboard assembly as in claim 1, wherein the connection cord has a connector on one end thereof and connected to the computer.

5. The wireless mouse and keyboard assembly as in claim 1, wherein the connection cord has two connectors on one end thereof and connected to the computer.

6. A computer keyboard receiving a wireless signal,
the computer keyboard having:
a wireless receiver therein and receiving the wireless signal;
a conversion unit used convert the wireless signal from the wireless receiver into a digital signal, which is sent to a keyboard processor for further processing;
the digital signal processed by the keyboard processor being sent to the computer through a connection cord.

7. The computer keyboard as in claim 6, wherein the computer keyboard receiving the wireless signal from a wireless mouse.
